(19) United States
(12) Patent Application Publication
(10) Pub. No.: US 2021/0294779 A1
(43) Pub. Date: Sep. 23, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventors: Hiroshi KATSURABAYASHI, Kanagawa (JP); Shigeki KAMIYA, Tokyo (JP); Tetsuo IYODA, Kanagawa (JP)

(73) Assignee: FUJIFILM BUSINESS INNOVATION CORP., Tokyo (JP)

(21) Appl. No.: 17/060,349

(22) Filed: Oct. 1, 2020

(30) Foreign Application Priority Data
Mar. 23, 2020 (JP) 2020-051506

(51) Int. Cl. G06F 16/21; G06F 40/197; G06F 16/23

(52) U.S. Cl. CPC G06F 16/219; G06F 16/2358; G06F 40/197

(57) ABSTRACT

An information processing apparatus includes a processor configured to manage a document and a distribution destination of the document on a distribution-pattern basis for a distribution pattern of the document, and process the document on the distribution-pattern basis.

### CROSS-REFERENCE TO RELATED APPLICATIONS

This application is based on and claims priority under 35 USC 119 from Japanese Patent Application No. 2020-051506 filed Mar. 23, 2020.

### BACKGROUND

### (i) Technical Field

The present disclosure relates to an information processing apparatus and a non-transitory computer readable medium.

### (ii) Related Art

The distribution of an electronic document distributed to distribution destinations by using a file server, e-mail, or the like is managed on occasions.

Japanese Unexamined Patent Application Publication No. 2008-117265 describes a system that stores distribution destination data regarding documents in a table on a per document-type basis. The distribution destination data includes information regarding the distribution destination of the documents and the file formats of the respective documents at the time when the documents are distributed. In response to a request to distribute a document, the system converts the file format of the document to a file format for a user at the distribution destination on the basis of the distribution destination data and stores the document in the user folder in the distribution destination apparatus.

### SUMMARY

It is conceivable that the distribution destinations of documents are individually managed on a per document basis. However, redistributing a document to a distribution destination, managing authority to access a document, or the like in such a system requires processing per document and efforts for the processing.

Aspects of non-limiting embodiments of the present disclosure relate to providing a system enabled to process distributed documents more easily than in a case where the distribution of the documents is managed on a per document basis.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to manage a document and a distribution destination of the document on a distribution-pattern basis for a distribution pattern of the document, and process the document on the distribution-pattern basis.

### BRIEF DESCRIPTION OF THE DRAWINGS

An exemplary embodiment of the present disclosure will be described in detail based on the following figures, wherein:

FIG. 1 is a block diagram illustrating an example functional configuration of a document system according to this exemplary embodiment;

FIG. 2 is a block diagram illustrating an example hardware configuration of the document system according to this exemplary embodiment;

FIG. 3 is a view illustrating an example distributed document management table;

FIG. 4 is a view illustrating an example distribution pattern management table;

FIG. 5 is a flowchart illustrating an example of processing by a redistribution destination selection section;

FIG. 6 is a view illustrating an example distribution pattern search screen;

FIG. 7 is a view illustrating an example history display screen;

FIG. 8 is a view illustrating an example history display screen;

FIG. 9 is a view illustrating an example distribution state display screen; and

FIG. 10 is a flowchart illustrating a different example of processing by the redistribution destination selection section.

### DETAILED DESCRIPTION

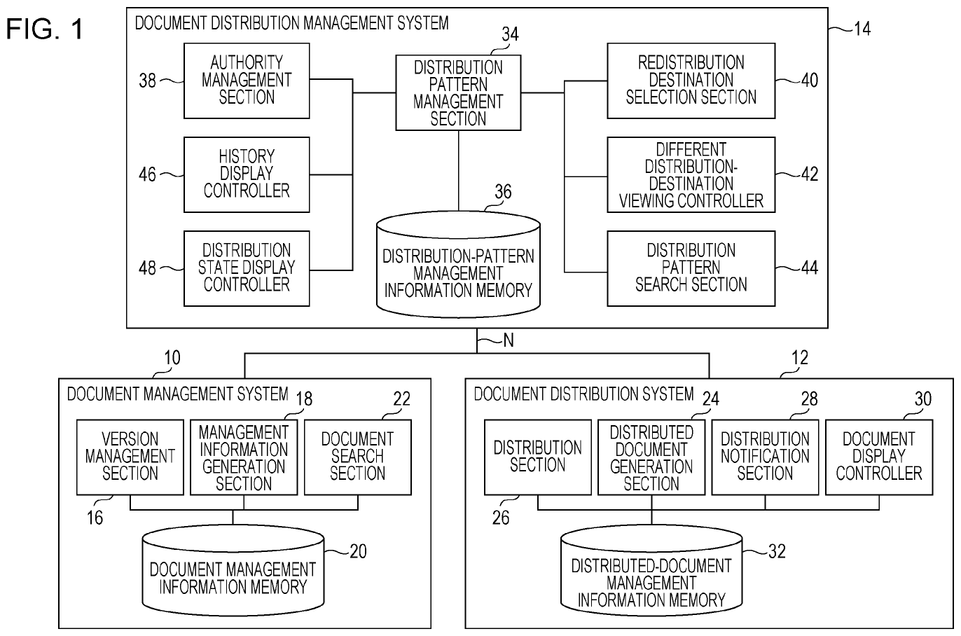

A document system according to this exemplary embodiment will be described with reference to FIG. 1. FIG. 1 illustrates an example functional configuration of the document system according to this exemplary embodiment.

A “document” in this exemplary embodiment is content data distributable as one unit (for example, one file), and the type of the data is not particularly limited. For example, a document conceptually includes text data, document data generated by word processor software, a spreadsheet data generated by spreadsheet software, computer aided design (CAD) data, image data (for example, still image data and moving image data), audio data, multimedia data, page data displayed by a web browser, data generated, edited, and read by a personal computer (hereinafter, referred to as a PC), and other pieces of data.

In the document system according to this exemplary embodiment, a document and the distribution destination of the document are managed on a distribution-pattern basis for the distribution pattern of the document, and the document is processed on the distribution-pattern basis.

Distributing a document is, for example, transmitting a document to a distribution destination by using a file server, e-mail, a social networking service (SNS), or the like. Examples of a document distribution method include a method by which a document stored in a document memory device such as a file server is downloaded at the distribution destination in response to a request from a user and a method by which a document is directly transmitted to the distribution destination from the distribution source. It goes without saying that a document may be distributed by a method other than these. One or more documents may also be distributed to multiple distribution destinations. For example, multiple documents may be collectively (for example, together) distributed to one or more distribution destinations.

In this exemplary embodiment, one or more documents are distributed to one or more distribution destinations, and a group of pieces of information regarding the distribution is managed as a distribution pattern. For example, the one or more distributed documents and the one or more distribution destinations are managed on a per distribution-pattern basis. A specific example is taken for explanation. Multiple documents are collectively distributed to one or more distribution destinations. The distribution event is managed as a distribution pattern, and the multiple distributed documents and the one or more distribution destinations are managed as information belonging to one distribution pattern.

Processing performed on a document is, for example, reading, editing, printing, distributing, and redistributing the document. Processing other than these may be performed on the document.

The document system according to this exemplary embodiment includes, for example, a document management system 10, a document distribution system 12, and a document distribution management system 14. The document management system 10, the document distribution system 12, and the document distribution management system 14 are each able to communicate with a different system through a communication path N. The communication path N is, for example, a network such as a local area network (LAN) or the Internet. It goes without saying that each system may communicate with a different system by using short distance wireless communication such as Bluetooth (registered trademark). Note that the document distribution management system 14 corresponds to an example of an information processing apparatus.

In the example illustrated in FIG. 1, the document management system 10, the document distribution system 12, and the document distribution management system 14 are configured as separate systems; however, all or some of the systems may be configured as one system.

The document management system 10 is a system that manages documents and includes, for example, a version management section 16, a management information generation section 18, a document management information memory 20, and a document search section 22.

The version management section 16 manages the version of each document. For example, if the content of a document is changed (for example, if a document is revised), the version management section 16 manages the document resulting from the change as a new version of the document.

The management information generation section 18 generates document management information for managing the document. The document management information is, for example, information for managing information on a per document basis in association with document identification information (for example, a document identification (ID)) that is information for identifying the document. The managed information includes information indicating the name of the document, information indicating the creator of the document, information indicating the date and time when the document is created, information indicating the memory area storing the document (for example, the address of the memory area), a keyword representing the feature of the document, and information indicating a document type (such as a contract, requirement specifications, functional specifications, an estimation sheet, or an order sheet). For example, the management information generation section 18 issues the document identification information on the per document basis and associates the document identification information with the document. If a new document is generated after the content of the document is changed, the management information generation section 18 issues document identification information for identifying the new document and associates the document identification information with the new document. The information indicating the name, the information indicating the creator, the information indicating the creation date and time, the keyword, and the information indicating the type are, for example, associated with the document in advance. The management information generation section 18 acquires the pieces of information from the document, associates the document identification information with the document, and registers the pieces of information in the document management information. For example, when the document is registered in the document management system 10, the management information generation section 18 generates document management information for the document. A document generated by a terminal apparatus such as a PC or a document stored in the apparatus such as a server may be registered in the document management system 10. The document may be stored in the document management system 10 or in a different apparatus (such as a terminal apparatus or a server).

Note that the management information generation section 18 may generate a processed document by processing a document. For example, the management information generation section 18 may generate an encrypted document by encrypting a document. Information indicating an encryption key used for the encryption process may be included in the document management information. The processed document may be stored in the document management system 10 or in a different apparatus (such as a terminal apparatus or a server).

The document management information memory 20 stores the document management information. The management information generation section 18 stores the generated document management information in the document management information memory 20. Note that the document may be stored in the document management information memory 20.

The document search section 22 searches for a document registered in the document management system 10. For example, the document identification information, the name of the document, or the like is used as a search key. The document search section 22 searches for the document by using the search key. The search key is given by a user by using, for example, a terminal apparatus or the like.

The document distribution system 12 is a system that distributes a document to at least one distribution destination and includes, for example, a distributed document generation section 24, a distribution section 26, a distribution notification section 28, a document display controller 30, and a distributed-document management information memory 32.

The distributed document generation section 24 generates a document to be distributed. The distributed document may be the document itself or may be a processed document generated by performing processing (for example, the encryption process) on the document. For example, the distributed document generation section 24 generates an encrypted document by executing the encryption process on the document. The document management system 10 may also generate and distribute a processed document. Hereinafter, a document to be distributed is referred to as a distributed document.

If a document to be distributed is stored in the document management system 10, the distributed document generation section 24 acquires the document from the document management system 10 and generates a distributed document. If the document to be distributed is stored in a different apparatus (such as a terminal apparatus or a server) other than the document management system 10, the distributed document generation section 24 acquires the document from the different apparatus and generates the distributed document.

For example, the distributor designates document identification information regarding the document to be distributed or the name thereof by using the terminal apparatus or the user interface (hereinafter, referred to as a UI) of the document system. The distributed document generation section 24 acquires the document having the document identification information or the name designated by the user and generates a distributed document on the basis of the document.

The distributed document generation section 24 also generates distributed document management information for managing the distributed document. The distributed document management information is, for example, information for managing information on a per distributed-document basis in association with distributed document identification information (for example, a distributed document ID) that is information for identifying the distributed document. The managed information includes bibliographic information, attribute information that is information indicating the attribute of the distributed document, and information indicating the memory area storing the original document (for example, the address of the memory area used for generating the distributed document). For example, the distributed document generation section 24 issues the distributed document identification information on the per distributed-document basis and associates the distributed document identification information with the distributed document. The bibliographic information includes, for example, information indicating the name of a document, information indicating the creator of the document, information indicating the date and time when the document is created, and the like and is in advance associated with the document. The attribute information includes, for example, document identification information used for identifying the document in the document management system 10, a keyword representing the feature of the document, information indicating the type of the document, and the like and is in advance associated with the document. The distributed document generation section 24 acquires the information associated with the document from the document and registers the information in the distributed document management information in association with the distributed document identification information. If the distributed document is an encrypted document, information indicating an encryption key is included in the distributed document management information.

The distributed document generation section 24 also issues a distributed document ID every time a distributed document is distributed and manages the distributed document ID on a per distribution-event basis. For example, for a document having a document ID, different distributed document IDs varying with respective distribution events are issued and managed. A specific example is taken for explanation. A distributed document is generated on the basis of the document having the document ID “D1”. When the distributed document is distributed to a distribution destination, for example, the distributed document ID “Document X1” is issued and managed. If a distributed document is generated on the basis of the document having the same document ID “D1” (the same document as the document previously distributed) on a different occasion and is distributed to a distribution destination, the distributed document ID “Document X2” different from the distributed document ID “Document X1” previously issued is issued and managed. As described above, the distributed document is managed in such a manner as to be assigned a distributed document ID different from a document ID issued by the document management system 10. In addition, even for the same document, different distributed document IDs varying with the respective distribution events are issued and managed. Accordingly, the use of only the distributed document ID does not enable the distributed documents to be identified as each other (that is, it is not possible to determine whether distributed documents are identified as the same document). That is, even if multiple distributed documents are identical, only the distributed document ID does not identify the distributed documents as the same distributed document. Further, in other words, if the document management system 10 manages a document by using a document ID, and if the document distribution system 12 manages a distributed document by using a distributed document ID, it is not possible to identify the document managed by the document management system 10 as the distributed document managed by the document distribution system 12. Although the use of the name of the document for identifying a document is conceivable, the name is not necessarily correct, and thus the name does not necessarily identify the document correctly. In this exemplary embodiment, the document ID and the distributed document ID are managed in association with each other, and it is thus possible to determine whether multiple distributed documents are identified as the same document.

A distributed document may be stored in the document distribution system 12 or in a different apparatus (such as a terminal apparatus or a server).

The distribution section 26 distributes a distributed document generated by the distributed document generation section 24 to at least one distribution destination. The distribution destination may be designated by a distributor or may be decided in advance. For example, the distribution section 26 may transmit the distributed document to the document memory device of a file server or the like to store the distributed document in the document memory device, and the distributed document may be downloaded to the distribution destination in response to a request from a user. Alternatively, the distribution section 26 may transmit the distributed document directly to the distribution destination. The distribution destination is, for example, a terminal apparatus such as a PC, a server, or another apparatus.

The distribution notification section 28 notifies a target user at the distribution destination that the distributed document is distributed to the distribution destination. For example, the distribution notification section 28 uses e-mail, a different reporting function (the notification function of a terminal apparatus such as a smartphone), or the like to notify the target user at the distribution destination that the distributed document is distributed to the target user at the distribution destination. The distribution notification section 28 does not have to be provided in the document distribution system 12. In this case, the distribution of the distributed document to the distribution destination is not notified to the target user at the distribution destination.

The document display controller 30 displays the distributed document on the display. The display may be provided in the document distribution system 12 or a system or an apparatus other than the document distribution system 12.

The distributed-document management information memory 32 stores distributed document management information. The distributed document generation section 24 stores the generated distributed document management information in the distributed-document management information memory 32. The distributed-document management information memory 32 may store a distributed document.

The document distribution management system 14 is a system that manages distributed documents on a distribution-pattern basis and includes, for example, a distribution pattern management section 34, a distribution-pattern management information memory 36, an authority management section 38, a redistribution destination selection section 40, a different distribution-destination viewing controller 42, a distribution pattern search section 44, a history display controller 46, and a distribution state display controller 48.

The distribution pattern management section 34 generates distribution pattern management information for managing a distributed document and a distribution destination on the distribution-pattern basis and manages the distributed document and the distribution destination on the distribution-pattern basis. The distribution pattern management information is, for example, information for managing information on the distribution-pattern basis in association with distribution pattern identification information that is information for identifying a distribution pattern (for example, a distribution ID). The managed information includes information indicating the name of the distribution pattern, distributed document identification information regarding the distributed document distributed in the distribution pattern, information indicating the distribution destination in the distribution pattern, information indicating the date and time when the distributed document is distributed, and information for identifying the distributor who distributes the distributed document. For example, the distribution pattern management section 34 issues the distribution pattern identification information on the distribution-pattern basis and associates the distribution pattern identification information regarding the distribution pattern with the distributed document identification information regarding the distributed document belonging to the distribution pattern. Even for the same distributed document, different distribution IDs are issued every distribution event and are managed. That is, when a certain distributed document is distributed, a distribution ID is issued, and the distributed document thereof is associated with the distribution ID. If the same distributed document is distributed on a difference occasion, a distribution ID different from the previously issued distribution ID is issued and is associated with the distributed document. The distribution pattern is named by, for example, the distributor. Pieces of information indicating the distribution destination and information indicating the distribution date and time are transmitted from the document distribution system 12 to the document distribution management system 14. The distribution pattern management section 34 associates the pieces of information with the distribution pattern identification information on the per distribution-pattern basis.

The distribution-pattern management information memory 36 stores distribution pattern management information. The distribution pattern management section 34 stores generated distribution pattern management information in the distribution-pattern management information memory 36.

The authority management section 38 manages authority for a distributed document on the distribution-pattern basis. Authority for a distributed document is authority to access the distributed document. The authority conceptually includes, for example, authority to read the distributed document, authority to edit the distributed document, authority to print the distributed document, authority to redistribute the distributed document, authority to delete the distributed document belonging to a distribution pattern, and the like.

The authority management section 38 may manage the authority for the distributed document on a per user basis, a per group basis, or the per distributed-document basis. An authorized user or group is permitted to use the distributed document within the range of the given authority. For example, the user or the group at the distribution destination of the distributed document is permitted to use the distributed document within the range of the given authority. If authority is set for the distributed document, the user or the group to use the distributed document is permitted to use the distributed document within the range of the set authority. For example, a distributor designates authority, and the authority management section 38 sets the authority in accordance with the designation by the distributor.

The authority to edit the distributed document is, for example, authority to annotate the distributed document such as to put a sticky note or authority to change the content of the distributed document. A user or a group given the editing authority is permitted to edit the distributed document. If the editing authority is set for the distributed document, the user or the group to use the distributed document is permitted to edit the distributed document. For example, the user or the group at the distribution destination of the distributed document is permitted to edit the distributed document with a terminal apparatus or the like.

A user or a group given the viewing authority is permitted to view the distributed document. If the viewing authority is set for the distributed document, the user or the group to use the distributed document is permitted to view the distributed document. For example, the user or the group at the distribution destination of the distributed document is permitted to view the distributed document displayed on the display.

A user or a group given the printing authority is permitted to print the distributed document. If the printing authority is set for the distributed document, the user or the group to use the distributed document is permitted to print the distributed document. For example, the user or the group at the distribution destination of the distributed document is permitted to give an instruction to print the distributed document by using a terminal apparatus or a printer and to thereby print the distributed document with a printer.

A user or a group given the redistribution authority is permitted to redistribute the distributed document to a distribution destination. If the redistribution authority is set for the distributed document, the user or the group to use the distributed document is permitted to redistribute the distributed document to the distribution destination.

A user or a group given the deletion authority is permitted to delete the distributed document from the distribution pattern. The distributed document deleted from the distribution pattern does not belong to the distribution pattern any more. Accordingly, when a distributed document also belonging to the distribution pattern is redistributed, the deleted distributed document is not redistributed.

An expiration date may be set for authority. In this case, editing, viewing, printing, redistributing, deleting, or the like of the distributed document only within the expiration date is permitted.

The authority management section 38 may nullify the authority for the distributed document. The authority management section 38 may nullify authority given to a user or a group or authority set for the distributed document. The authority management section 38 may nullify all or at least one of the authority types. The authority management section 38 may give authority to cancel the authority nullification to the user or the group or set the cancellation authority for the distributed document. If the authority given to the user or the group is nullified, the user or the group is not permitted to perform an operation (such as editing, viewing, printing, or redistributing) having been permitted in accordance with the authority. If authority set for the distributed document is nullified, an operation having been permitted on the distributed document in accordance with the authority is not permitted.

A specific example of a scenario of the authority nullification is described. For example, it is conceivable that three documents (for example, specifications, drawings, and a parts list) are distributed to three companies (for example, Company A, Company B, and Company C), and thereafter authority for the three documents (for example, the viewing authority) distributed to Companies B and C is nullified due to placement of an order with Company A. When the authority given to Companies B and C is nullified, Companies B and C are not permitted to view the three documents.

The redistribution destination selection section 40 selects a distribution destination to which a distributed document is redistributed. For example, if the content of the distributed document is changed, the redistribution destination selection section 40 identifies the distribution pattern to which the distributed document having the changed content belongs and selects a distribution destination to which the distributed document belonging to the distribution pattern is redistributed. The redistribution destination selection section 40 may redistribute the distributed document to the distribution destination on the distribution-pattern basis. Note that the distribution section 26 of the document distribution system 12 may redistribute the distributed document to the distribution destination. A change, an addition, or a deletion may be made to the redistribution destination by the distributor.

The different distribution-destination viewing controller 42 performs control of whether to permit a user at the distribution destination of a distributed document to view a record of the distribution of the distributed document to a different user other than the user. For example, if the same distributed document is distributed to multiple distribution destinations, a user at one of the distribution destinations who is permitted to view the distributed document is permitted to view the names, the addresses, or the like of the other distribution destinations to which the distributed document is distributed. For example, if the distributed document is distributed by e-mail, the user at the distribution destination permitted the viewing is permitted to view the names, the e-mail addresses, or the like of the other distribution destinations. For example, in the terminal apparatus or the like of the user at the distribution destination, the e-mail addresses or the like of the other distribution destinations are displayed in the destination field of the e-mail. A user at a distribution destination who is not permitted the viewing is not permitted to view the names, the addresses, or the like of the other distribution destinations. For example, in the terminal apparatus or the like of the user at the distribution destination, the e-mail addresses or the like of the other distribution destinations are not displayed in the destination field of the e-mail.

The distribution pattern search section 44 searches for a distributed document on the distribution-pattern basis. As search keys for the searching, for example, the name of a distribution pattern, a distribution destination, a distribution date and time, and the distributor of the distributed document are used.

The history display controller 46 performs control of the displaying of information regarding the history of a replacement, an addition, a redistribution event, or the like of a distributed document on the distribution-pattern basis. The information regarding the history is displayed, for example, on the terminal apparatus used by the distributor, an administrator, a different worker, or the like.

The distribution state display controller 48 performs control of the displaying of information regarding the distribution state of a distributed document. The information regarding the distribution state is displayed, for example, on the terminal apparatus used by the distributor, an administrator, a different worker, or the like. For example, the distributed document and the distribution destination are displayed on the distribution-pattern basis.

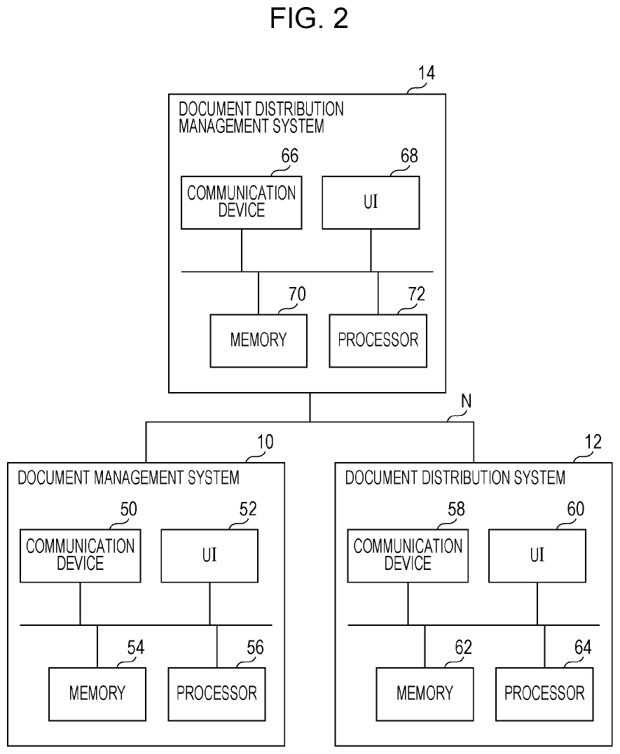

Hereinafter, the hardware configuration of the document system according to this exemplary embodiment will be described with reference to FIG. 2. FIG. 2 illustrates an example hardware configuration of the document system according to this exemplary embodiment.

The document management system 10 includes, for example, a communication device 50, a UI 52, a memory 54, and a processor 56.

The communication device 50 is a communication interface (such as a network interface) having a communication chip and has functions of transmitting data to a different apparatus or system and receiving data transmitted from the different apparatus or system.

The UI 52 is a user interface and includes at least one of a display and an operation device. The display is a liquid crystal display, an electro luminescence (EL) display, or another display. The operation device is a keyboard, an input key, an operation panel, or another device. The UI 52 may be a UI such as a touch panel doubly serving as the display and the operation device.

The memory 54 is a device composed of one or more memory areas where data is stored. The memory 54 is, for example, a hard disk drive, any of various memories (such as a random-access memory (RAM), a dynamic random-access memory (DRAM), or a read-only memory (ROM)), another memory device (such as an optical disk), or combination of these. For example, the document management information memory 20 is implemented by the memory 54.

The processor 56 performs control of operations of the components of the document management system 10. The processor 56 may include a memory. For example, the version management section 16, the management information generation section 18, and the document search section 22 are implemented by the processor 56.

The document distribution system 12 includes, for example, a communication device 58, a UI 60, a memory 62, and a processor 64.

The communication device 58 is a communication interface (such as a network interface) having a communication chip and has functions of transmitting data to a different apparatus or system and receiving data transmitted from the different apparatus or system.

The UI 60 is a user interface and includes at least one of a display and an operation device. The display is a liquid crystal display, an EL display, or another display. The operation device is a keyboard, an input key, an operation panel, or another device. The UI 60 may be a UI such as a touch panel doubly serving as the display and the operation device.

The memory 62 is a device composed of one or more memory areas where data is stored. The memory 62 is, for example, a hard disk drive, any of various memories (such as a RAM, a DRAM, or a ROM), another memory device (such as an optical disk), or combination of these. For example, the distributed-document management information memory 32 is implemented by the memory 62.

The processor 64 performs control of operations of the components of the document distribution system 12. The processor 64 may include a memory. For example, the distributed document generation section 24, the distribution section 26, the distribution notification section 28, and the document display controller 30 are implemented by the processor 64.

The document distribution management system 14 includes, for example, a communication device 66, a UI 68, a memory 70, and a processor 72.

The communication device 66 is a communication interface (such as a network interface) having a communication chip and has functions of transmitting data to a different apparatus or system and receiving data transmitted from the different apparatus or system.

The UI 68 is a user interface and includes at least one of a display and an operation device. The display is a liquid crystal display, an EL display, or another display. The operation device is a keyboard, an input key, an operation panel, or another device. The UI 68 may be a UI such as a touch panel doubly serving as the display and the operation device.

The memory 70 is a device composed of one or more memory areas where data is stored. The memory 70 is, for example, a hard disk drive, any of various memories (such as a RAM, a DRAM, or a ROM), another memory device (such as an optical disk), or combination of these. For example, the distribution-pattern management information memory 36 is implemented by the memory 70.

The processor 72 performs control of operations of the components of the document distribution management system 14. The processor 72 may include a memory. For example, the distribution pattern management section 34, the authority management section 38, the redistribution destination selection section 40, the different distribution-destination viewing controller 42, the distribution pattern search section 44, the history display controller 46, and the distribution state display controller 48 are implemented by the processor 72.

Hereinafter, the document system according to this exemplary embodiment will be described in more detail by taking a specific example.

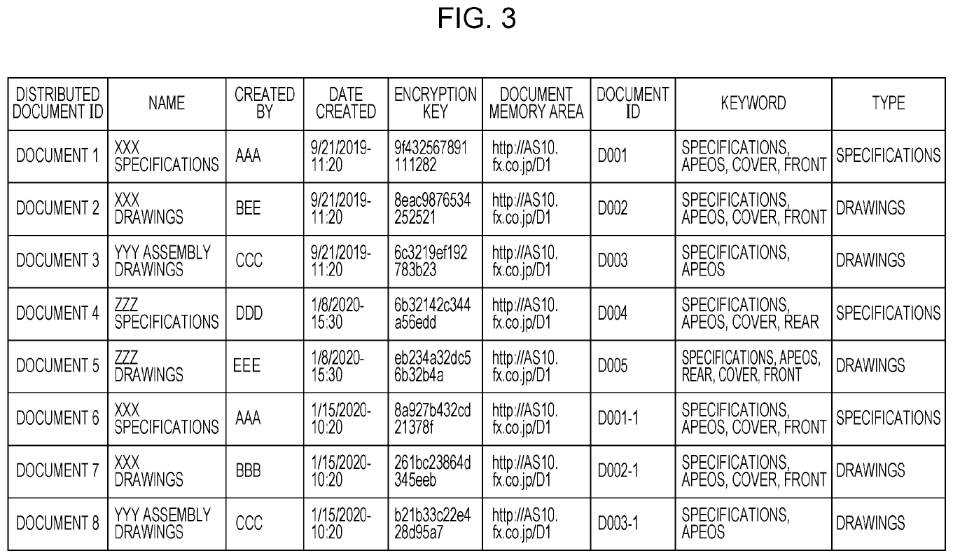

An example of the distributed document management information stored in the distributed-document management information memory 32 will be described with reference to FIG. 3. FIG. 3 illustrates an example distributed document management table. The distributed document management table is an example of the distributed document management information.

In the distributed document management table, for example, a distributed document ID is associated with information indicating a name, information indicating a creator, information indicating a creation date and time, information indicating an encryption key, information indicating a document memory area, a document ID, one or more keywords, and information indicating a type on a per distributed-document basis.

The distributed document ID is an example of the distributed document identification information. The name is the name of the original document used for generating a distributed document. The creator is a person who creates the original document. The creation date and time is the creation date and time when the original document is created. The encryption key is an encryption key used for encrypting the distributed document. The document memory area is a memory area storing the original document (for example, a memory area in the document management system 10, a server, or the like). The document ID is document identification information regarding the original document (that is, information used for identifying a document by the document management system 10). Each keyword is information representing the feature of the original document. The type is the type of the distributed document.

The distributed document ID is an ID different from the document ID and is issued every time a distributed document is distributed. For example, a distributed document is generated and distributed on the basis of the document having the document ID “D001”, and the distributed document ID “Document 1” for the distribution is issued. If the distributed document is distributed on a difference occasion, a distributed document ID different from the distributed document ID “Document 1” is issued and managed. As described, a distributed document ID is issued every distribution event and is managed.

For example, when a distributed document is generated, the above-described information regarding the distributed document is registered in the distributed document management table.

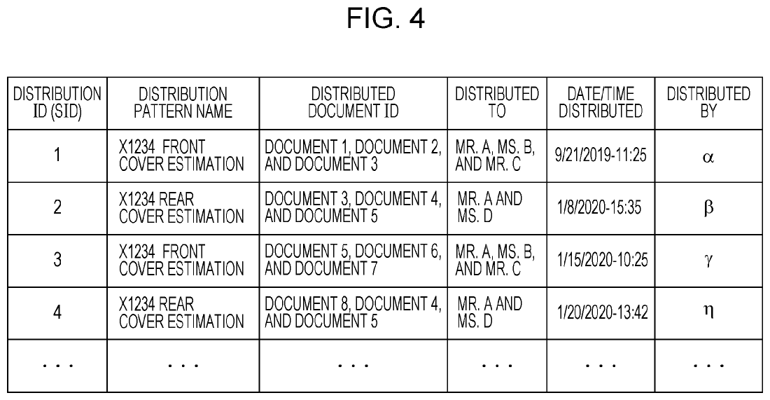

An example of the distribution pattern management information stored in the distribution-pattern management information memory 36 will be described with reference to FIG. 4. FIG. 4 illustrates an example of the distribution pattern management table. The distribution pattern management table is an example of the distribution pattern management information.

In the distribution pattern management table, for example, a distribution ID is associated with information indicating the name of a distribution pattern, a distributed document ID, information indicating a distribution destination, information indicating a distribution date and time, and information indicating a distributor on the per distribution-pattern basis.

The distribution ID is an example of the distribution pattern identification information. The distributed document ID associated with the distribution ID is distributed document identification information regarding the distributed document belonging to the distribution pattern represented by the distribution ID. The distribution destination associated with the distribution ID is the distribution destination of the distributed document belonging to the distribution pattern represented by the distribution ID. The distribution date and time associated with the distribution ID is a date and time when the distributed document belonging to the distribution pattern represented by the distribution ID is distributed to the distribution destination. The distributor associated with the distribution ID is a person who distributes the distributed document belonging to the distribution pattern represented by the distribution ID.

The distribution ID is associated with one or more distributed document IDs and information indicating one or more distribution destinations. Multiple distributed documents associated with the same distribution ID are distributed to the same distribution destination by the document distribution system 12. If multiple distribution destinations are associated with one distribution ID, the multiple distributed documents are distributed to the multiple distribution destinations. For example, distributed documents associated with the same distribution ID are collectively distributed to the distribution destinations.

A specific example is taken for explanation. The distribution ID “1” is associated with the distributed document IDs “Document 1”, “Document 2”, and “Document 3”, the distribution destinations “A”, “B”, and “C”, and a distributor α. That is, the distributed documents respectively having the distributed document IDs “Document 1”, “Document 2”, and “Document 3” belong to the distribution pattern having the distribution ID “1”. These distributed documents are collectively distributed to the distribution destinations “A”, “B”, and “C” by the distributor α.

A distribution ID is issued every time a distributed document is distributed. For example, if the distributed documents respectively having the distributed document IDs “Document 1”, “Document 2”, and “Document 3” are distributed at an event different from the distribution event having the distribution ID “1”, a new distribution ID is issued and is associated with the distributed document IDs “Document 1”, “Document 2”, and “Document 3”. As described above, a different distribution ID is issued every distribution event.

For example, authority for a distributed document is managed on the distribution-pattern basis. A specific example is taken for explanation. If authority is set for the distribution pattern having the distribution ID “1”, the use of every distributed document belonging to the distribution pattern within the range of the set authority is permitted. For example, if authority to only view the distributed document is set, a user at the distribution destination is permitted to only view the distributed document.

A change, an addition, or a deletion may be made to distribution destinations in a distribution pattern to which a distributed document belongs, and the distributed document may be distributed to the distribution destinations. For example, if a change is made to distribution destinations belonging to the distribution pattern having the distribution ID “1”, every distributed document belonging to the distribution pattern is distributed to the distribution destinations resulting from the change.

A change, an addition, or a deletion may also be made to a distributed document in the distribution pattern, and the distributed document belonging to the distribution pattern may be distributed to the distribution destinations. For example, assume that a distributed document belonging to the distribution pattern having the distribution ID “1” is deleted, a new distributed document is added to the distribution pattern, or a distributed document belonging to the distribution pattern is replaced with a different distributed document. In this case, distributed documents belonging to the distribution pattern may be distributed to the distribution destinations.

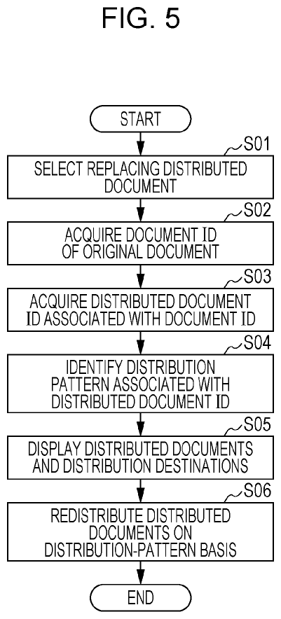

Hereinafter, an example of processing by the redistribution destination selection section 40 will be described in detail with reference to FIG. 5. FIG. 5 is a flowchart illustrating the processing.

For example, the content of a distributed document distributed to distribution destinations is changed, a distributed document with the changed content and a different distributed document (that is, a distributed document with unchanged content) belonging to the same distribution pattern as that of distributed document with the changed content are redistributed to the distribution destinations. In other words, a distributed document with content yet to be changed is replaced with a distributed document with changed content, and the distributed document with the changed content is redistributed to the distribution destinations together with a different distributed document with unchanged content.

First, a replacing distributed document is selected (S01). In this case, a distributed document with changed content is selected as the replacing distributed document. The selection may be made by the redistribution destination selection section 40 or a person such as the distributor who distributes the distributed document, an administrator, or a different worker. In the case where the distributor selects the distributed document, for example, the distributor designates the name of the distributed document with the changed content by using the terminal apparatus thereof or a UI included in the document system and thereby selects the distributed document with the changed content as the replacing distributed document.

The redistribution destination selection section 40 acquires, from the document management system 10, the original document used for generating the document ID of distributed document selected in step S01 (S02). That is, the redistribution destination selection section 40 acquires the document ID of the original document used for generating the replacing distributed document. In this case, the content of the document having the document ID “D001” is changed, and the redistribution destination selection section 40 acquires the document ID “D001”.

The redistribution destination selection section 40 identifies a distributed document ID associated with the document ID acquired in step S02 in the distributed document management table illustrated in FIG. 3 and acquires the distributed document ID from the document distribution system 12 (S03). For example, the redistribution destination selection section 40 acquires the distributed document ID “Document 1” associated with the document ID “D001” from the document distribution system 12. The distributed document having the distributed document ID “Document 1” is the replacing distributed document.

The redistribution destination selection section 40 acquires the distribution ID associated with the distributed document ID acquired in step S03 in the distribution pattern management table illustrated in FIG. 4 (S04). The distribution pattern having the distribution ID is thereby identified. For example, the redistribution destination selection section 40 identifies the distribution ID “1” associated with the distributed document ID “Document 1”. The distribution pattern having the distribution ID “1” is thereby identified. The distributed document and the distribution destinations belonging to the distribution pattern having the distribution ID “1” are identified.

The redistribution destination selection section 40 causes the display to display the distributed document belonging to the distribution pattern identified in step S04 and the distribution destinations on the per distribution-pattern basis (S05). For example, information indicating the distributed document ID of the distributed document and the distribution destinations is displayed on the display. The information indicating the distributed document ID and the distribution destinations is displayed on the display of the terminal apparatus used by the distributor, an administrator, a different worker, or the like, on the display of the UI included in the document system, or on another display. For example, if the distribution pattern having the distribution ID “1” is identified, the distributed document IDs “Document 1”, “Document 2”, and “Document 3” are displayed because the distributed documents respectively having the distributed document IDs “Document 1”, “Document 2”, and “Document 3” belong to the identified distribution pattern. In addition, the distribution destinations “A”, “B”, and “C” belong to the distribution pattern, and thus information indicating these distribution destinations is displayed. At this time, the redistribution destination selection section 40 may change the display form of the distributed documents to discriminate between the distributed document with the changed content and the distributed document with unchanged content in the display. For example, the redistribution destination selection section 40 uses different colors for the respective distributed document IDs of the distributed document with the changed content and the distributed document with unchanged content in displaying the distributed document IDs on the display. Since the distributed document having the distributed document ID “Document 1” is the replacing distributed document in the example above, the redistribution destination selection section 40 uses respective different display colors as the color for the distributed document ID “Document 1” and the color for the distributed document IDs “Document 2” and “Document 3” in displaying the distributed document IDs on the display.

On the per distribution-pattern basis, the redistribution destination selection section 40 redistributes the distributed document with the changed content and the different distributed document belonging to the same distribution pattern as that of the distributed document with the changed content to the distribution destinations associated with the distribution pattern (S06). For example, the redistribution destination selection section 40 redistributes the distributed documents to the distribution destinations on the distribution-pattern basis by using the document distribution system 12. Since the distributed document having the distributed document ID “Document 1” is the replacing distributed document in the example above, the distributed document resulting from the change of the content thereof, the distributed documents respectively having the distributed document IDs “Document 2” and “Document 3” are redistributed to the distribution destinations “A”, “B”, and “C”. A new distribution ID different from the distribution ID “1” and new distributed document IDs for the respective distributed documents are issued, and the new distribution ID is associated with the new distributed document IDs.

The distributor may select a different replacing distributed document and redistribute the different replacing distributed document to the distribution destinations.

The distributor may change a redistribution destination, add a new redistribution destination, or delete a distribution destination. A condition for a change, an addition, or a deletion of a redistribution destination may be predetermined, and a distributed document may be redistributed to the distribution destination according to the condition.

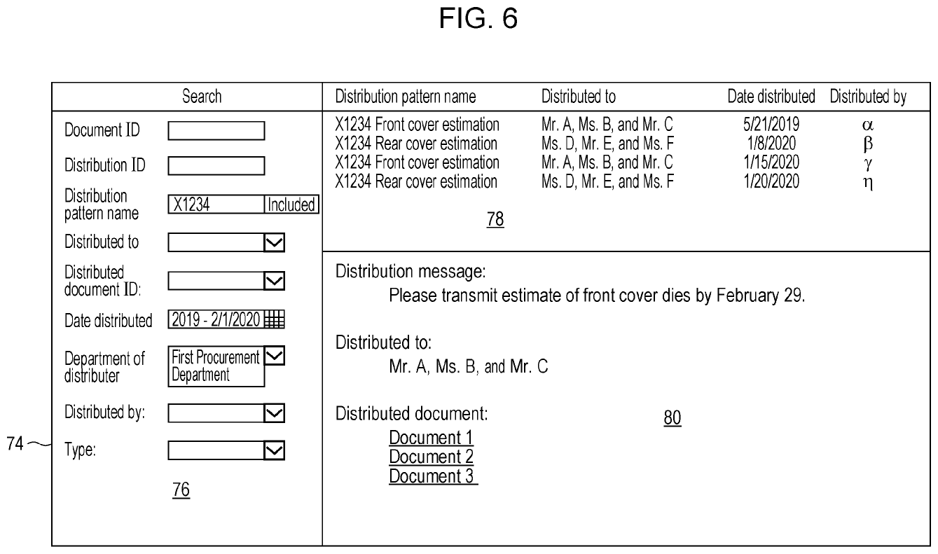

Hereinafter, processing by the distribution pattern search section 44 will be described in detail with reference to FIG. 6. FIG. 6 illustrates an example distribution pattern search screen. A distribution pattern search screen 74 is a screen displayed when a search for a distributed document is performed on the distribution-pattern basis.

The distribution pattern search screen 74 is displayed, for example, on the terminal apparatus of a distributor, an administrator, a different worker, or the like or the UI included in the document system. For example, when a distributor gives an instruction to display the distribution pattern search screen 74 by using their terminal apparatus or the UI of the document system, the distribution pattern search screen 74 is displayed on the terminal apparatus or the UI.

An input area 76 for search keys is displayed on the distribution pattern search screen 74. The input area 76 includes fields for respectively inputting, as the search keys, the document ID of the original document used for generating a distributed document, a distribution ID, the name of a distribution pattern, a distribution destination, a distributed document ID, a distribution date and time, a department to which a distributor belongs, the distributor, and a document type.

The distribution pattern search section 44 searches for a distributed document on the distribution-pattern basis by using the search keys input in the input area 76. For example, the distribution pattern search section 44 searches the distribution pattern management table illustrated in FIG. 4 for a distributed document matching the search keys. The search result is displayed in a display area 78.

In the example illustrated in FIG. 6, the names of the distribution patterns, distribution destinations, distribution dates, and distributors are displayed as the search results on the per distribution-pattern basis in the display area 78.

When the distributor designates a distribution pattern displayed in the display area 78, the distributed document ID of the distributed document belonging to the distribution pattern is displayed in a display area 80. In this case, the distribution pattern having the distribution pattern name “X1234 front cover estimation” is designated, and the distributed document IDs “Document 1”, “Document 2”, and “Document 3” of the distributed documents belonging to the distribution pattern are displayed in the display area 80. In addition, a message distributed together with the distributed documents, information indicating the distribution destinations, and the like are displayed in the display area 80.

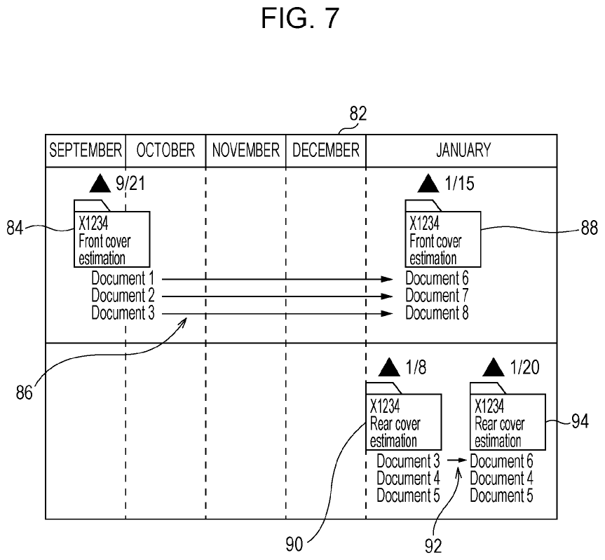

Hereinafter, processing by the history display controller 46 will be described with reference to FIG. 7. FIG. 7 illustrates an example history display screen. A history display screen 82 is a screen for displaying the distribution history of at least one distributed document on the distribution-pattern basis.

The history display screen 82 is displayed, for example, on the terminal apparatus of a distributor, an administrator, a different worker, or the like or the UI included in the document system. For example, when a distributor gives an instruction to display the history display screen 82 by using their terminal apparatus or the UI of the document system, the history display screen 82 is displayed on the terminal apparatus or the UI.

Information regarding the redistribution history of at least one distributed document is displayed on the history display screen 82 on the distribution-pattern basis. For example, the history display controller 46 displays the distributed document ID of each distributed document, information indicating the date and time when the distributed document is distributed, the distributed document ID of each replacing distributed document, and information indicating the redistribution date on the history display screen 82 on the distribution-pattern basis. Specifically, these pieces of information are displayed on the history display screen 82 in a time series on the basis of the distribution date and the redistribution date. The history display controller 46 acquires, for example, the information to be displayed on the history display screen 82 from the document management system 10, the document distribution system 12, and the document distribution management system 14 and displays the information on the history display screen 82.

For example, if redistribution is performed after the replacement of distributed documents belonging to the distribution pattern having the distribution ID “1”, the history display controller 46 displays information regarding a redistribution history on the history display screen 82. Specifically, the history display controller 46 displays an image 84 representing the distribution pattern having the distribution ID “1” on the history display screen 82 at a position corresponding to the date and time when the distributed documents belonging to the distribution pattern are distributed. The distributed documents belonging to the distribution pattern are distributed to the distribution destinations on September 21, and thus the image 84 is displayed at the position corresponding to the date. The image 84 represents, for example, the name of the distribution pattern. The history display controller 46 also displays the distributed document IDs of the distributed documents distributed on the date on the history display screen 82 in association with the image 84. In this case, the distributed documents respectively having the distributed document IDs “Document 1”, “Document 2”, and “Document 3” belong to the distribution pattern having the distribution ID “1” and are collectively distributed.

As represented by reference numeral 86, the content of the distributed document having the distributed document ID “Document 1” is changed, and the distributed document is replaced with the distributed document having the distributed document ID “Document 6”. The content of the distributed document having the distributed document ID “Document 2” is changed, and the distributed document is replaced with the distributed document having the distributed document ID “Document 7”. The content of the distributed document having the distributed document ID “Document 3” is changed, and the distributed document is replaced with the distributed document having the distributed document ID “Document 8”. The replacement is managed by the version management section 16 of the document management system 10. The distributed documents resulting from the replacement are the distributed documents belonging to the distribution pattern having the distribution ID “1” and redistributed to the distribution destinations.

The history display controller 46 displays an image 88 representing the distribution pattern having the distribution ID “1” on the history display screen 82 at the position corresponding to the date and time when the distributed documents belonging to the distribution pattern are redistributed. The image 88 represents, for example, the name of the distribution pattern. Since the distributed documents belonging to the distribution pattern are redistributed to the distribution destinations on January 15, the image 88 is displayed at the position corresponding to the date. The history display controller 46 also displays the distributed document IDs of the distributed documents redistributed on the date and time on the history display screen 82 in association with the image 88. In this case, the distributed documents respectively having the distributed document IDs “Document 6”, “Document 7”, and “Document 8” are redistributed to the distribution destinations as replacing distributed documents. That is, all of Documents 1, 2, and 3 are replaced, and the respective new documents are redistributed to the distribution destinations.

An image 90 representing the distribution pattern having the distribution ID “2” is also displayed at the position corresponding to the date and time when distributed documents belonging to the distribution pattern are distributed. Since the distributed documents belonging to the distribution pattern are distributed to the distribution destinations on January 8, the image 90 is displayed at the position corresponding to the date. The distributed documents respectively having the distributed document IDs “Document 3”, “Document 4”, and “Document 5” belong to the distribution pattern having the distribution ID “2”, and these distributed documents are collectively distributed.

As represented by reference numeral 92, the content of the distributed document having the distributed document ID “Document 3” is changed, and the distributed document is replaced with the distributed document having the distributed document ID “Document 6”. The distributed document resulting from the replacement (that is, “Document 6”) and unreplaced distributed documents (that is, “Document 4” and “Document 5”) are redistributed to the distribution destinations. If a distributed document is replaced as described above, a new distributed document resulting from the replacement and the other distributed documents not replaced and belonging to the same distribution pattern as that of the replaced distributed document are redistributed to the distribution destinations.

The history display controller 46 displays an image 94 representing the distribution pattern having the distribution ID “2” on the history display screen 82 at the position corresponding to the date and time when the distributed documents belonging to the distribution pattern are redistributed. The image 94 represents, for example, the name of the distribution pattern. Since the distributed documents belonging to the distribution pattern are redistributed to the distribution destinations on January 20, the image 94 is displayed at the position corresponding to the date. The history display controller 46 displays the distributed document IDs of the distributed documents redistributed on the date and time on the history display screen 82 in association with the image 94. In this case, the distributed documents respectively having the distributed document IDs “Document 6”, “Document 4”, and “Document 5” are redistributed to the distribution destinations.

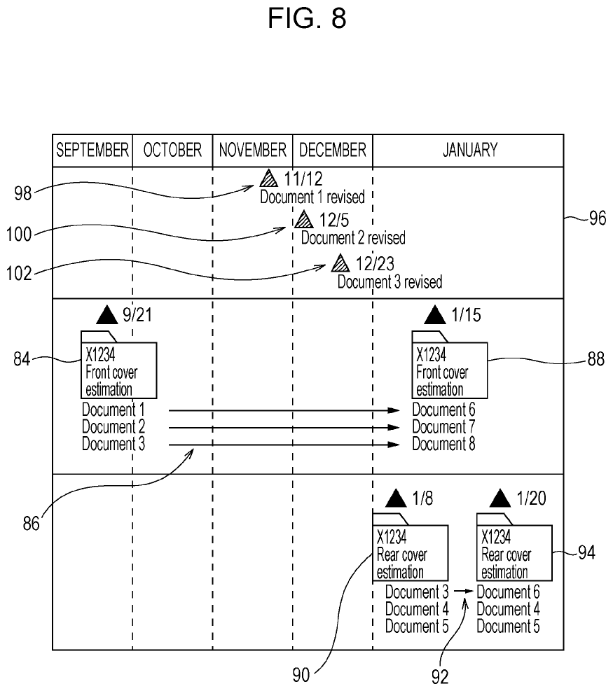

The history display controller 46 may display information regarding the change history of the content of a distributed document on the display together with information regarding the redistribution history of the distributed document. The processing will be described with reference to FIG. 8. FIG. 8 illustrates an example history display screen. A history display screen 96 is a screen for displaying, on the distribution-pattern basis, the distribution history of each distributed document and the change history of the content of the distributed document.

The information (for example, the information regarding the distribution history of the distributed documents) and the information regarding the change history of the content of the distributed documents that are displayed on the history display screen 82 illustrated in FIG. 7 are displayed on the history display screen 96. The images 84, 88, 90, 94, and the like are the same as the images displayed on the history display screen 82.

For example, the distributed document having the distributed document ID “Document 1” is revised on November 21. As represented by reference numeral 98, the history display controller 46 displays information indicating that the distributed document having the distributed document ID “Document 1” is revised at the position corresponding to the date. For example, a revision date and information for identifying the revised distributed document are displayed.

The distributed document having the distributed document ID “Document 2” is revised on December 5. As represented by reference numeral 100, information indicating that the distributed document having the distributed document ID “Document 2” is revised is displayed at the position corresponding to the date.

The distributed document having the distributed document ID “Document 3” is revised on December 23. As represented by reference numeral 102, the information indicating that the distributed document having the distributed document ID “Document 3” is revised is displayed at the position corresponding to the date.

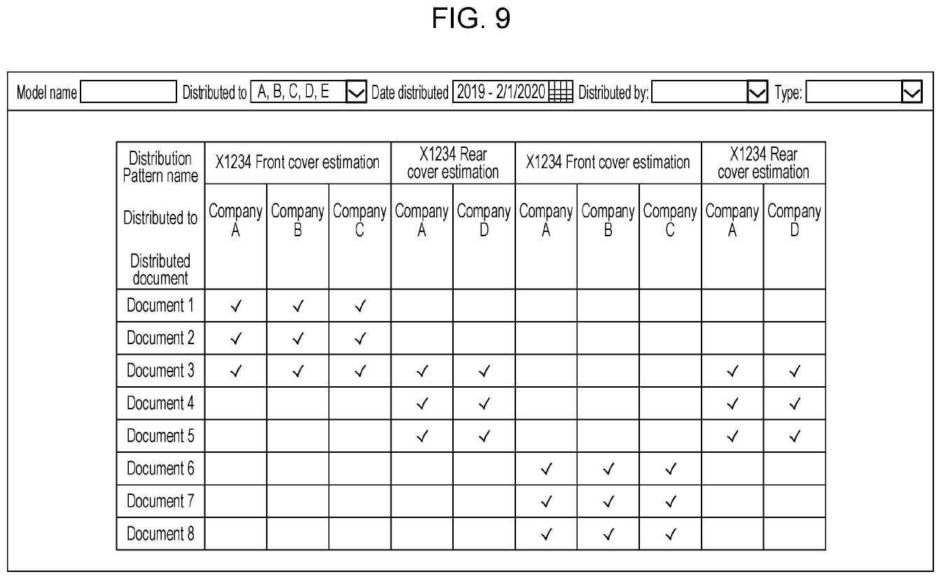

Hereinafter, processing by the distribution state display controller 48 will be described in detail with reference to FIG. 9. FIG. 9 illustrates an example distribution state display screen. A distribution state display screen 104 is a screen for displaying the distribution states of distributed documents.

The distribution state display screen 104 is displayed, for example, on the terminal apparatus of a distributor, an administrator, a different worker, or the like or the UI included in the document system. For example, when the distributor gives an instruction to display the distribution state display screen 104 by using their terminal apparatus or the UI of the document system, the distribution state display screen 104 is displayed on the terminal apparatus or the UI.

The distribution state display controller 48 displays information regarding the distribution states of distributed documents on the distribution state display screen 104. For example, the distributed document ID of each distributed document, the name of each distribution destination, the name of each distribution pattern, and the like are displayed on the distribution state display screen 104.

A distribution destination, a distribution date and time, a distributor, a document type, and the like may be used as search keys. For example, the area for inputting the search keys is displayed on the distribution state display screen 104. When a worker inputs a search key, the distribution state display controller 48 displays information matching the input search key on the distribution state display screen 104. For example, if a distribution destination is designated as a search key, searching is performed to find one or more distributed documents distributed to the distribution destination, and a list of found distributed documents is displayed on the distribution state display screen 104. The same holds true for the other search keys.

A specific example is taken for explanation. The distributed documents respectively having the distributed document IDs “Document 1”, “Document 2”, and “Document 3” belong to the same distribution pattern with the name “X1234 front cover estimation” and are collectively distributed to the distribution destinations “Company A”, “Company B”, and “Company C”. Information indicating the above is displayed on the distribution state display screen 104. The same holds true for the other distributed documents.

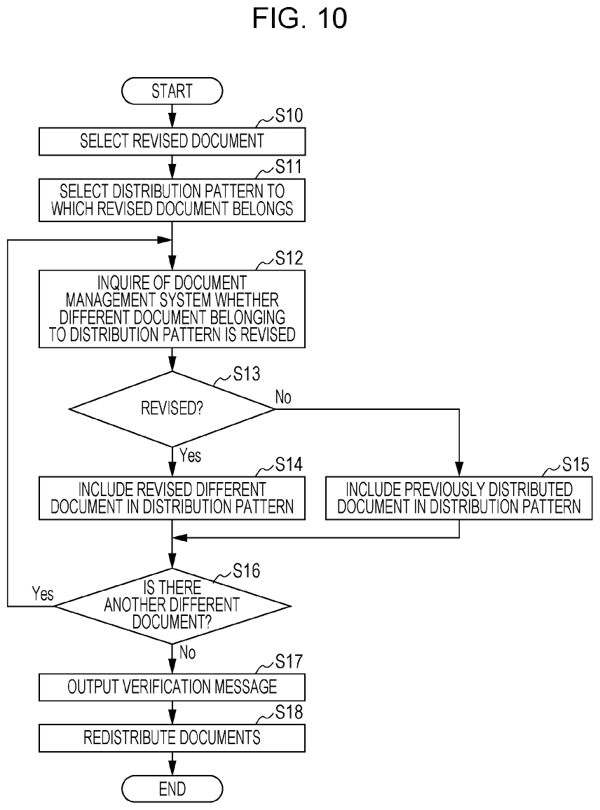

Hereinafter, a different example of processing by the redistribution destination selection section 40 will be described with reference to FIG. 10. FIG. 10 is a flowchart illustrating the processing.

First, the redistribution destination selection section 40 inquires of the document management system 10 whether a revised document (for example, a document with changed content) is present. If a revised document is present, the redistribution destination selection section 40 selects the revised document (S10).

The redistribution destination selection section 40 selects a distribution pattern to which the revised document belongs (S11). In more detailed explanation, the redistribution destination selection section 40 identifies a distributed document ID associated with the document ID of the revised document in the document management table illustrated in FIG. 3. The redistribution destination selection section 40 identifies a distribution ID associated with the identified distributed document ID in the distribution pattern management table illustrated in FIG. 4. The distribution pattern to which the revised document belongs is thereby identified. The redistribution destination selection section 40 selects the distribution pattern. The presence of the distribution pattern to which the revised document belongs means that a document yet to be revised is distributed to a distribution destination in the distribution pattern. If a different document together with the document yet to be revised is distributed to the distribution destination in the distribution pattern, the different document also belongs to the distribution pattern.

The redistribution destination selection section 40 selects a different document belonging to the selected distribution pattern and inquires of the document management system 10 whether the selected different document is revised (S12).

If the different document is revised (Yes in S13), the redistribution destination selection section 40 includes the revised different document in the distribution pattern selected in step S11 (S14).

If the different document is not revised (No in S13), the redistribution destination selection section 40 includes the not revised different document in the distribution pattern selected in step S11 (S15). That is, the different document having the same content as that of the previously distributed different document is included in the distribution pattern.

If another different document belongs to the distribution pattern selected in step S11 (Yes in S16), the processing proceeds to step S12, and steps S12 to S15 are performed. If a different document does not belong to the selected distribution pattern, the processing proceeds from step S12 to step S17.

If another different document does not belong to the distribution pattern selected in step S11 (No in S16), the redistribution destination selection section 40 outputs a message for verifying, with the distributor, whether to redistribute the documents belonging to the distribution pattern to the distribution destination (S17). For example, the message is displayed on the terminal apparatus of the distributor, the UI of the document system, or the like.

If the distributor gives a redistribution instruction, the document distribution system 12 redistributes the documents belonging to the distribution pattern selected in step S11 to the distribution destination (S18). If the distributor does not give a redistribution instruction, the documents are not redistributed. It goes without saying that even if the distributor does not give a redistribution instruction, the document distribution system 12 may redistribute the documents. In this case, the verification message may be displayed or does not have to be displayed.

A change may be made to the distribution destination for the redistribution. For example, the distributor uses the terminal apparatus of the distributor, the UI of the document system, or the like to change the distribution destination of the distributed documents belonging to the distribution pattern. If multiple distribution destinations belong to the distribution pattern, all or at least one of the distribution destinations may be changed. In addition, at least one of the multiple distribution destinations may be deleted from the distribution destinations, or a different distribution destination may be added thereto. As described above, a change, an addition, a deletion, or the like may be made to the distribution destinations in the distribution pattern.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
manage a document and a distribution destination of the document on a distribution-pattern basis for a distribution pattern of the document, and
process the document on the distribution-pattern basis.

2. The information processing apparatus according to claim 1,
wherein the processor manages authority to access the document on the distribution-pattern basis.

3. The information processing apparatus according to claim 1,
wherein the processor redistributes the document to a distribution destination on the distribution-pattern basis.

4. The information processing apparatus according to claim 2,
wherein the processor redistributes the document to a distribution destination on the distribution-pattern basis.

5. The information processing apparatus according to claim 3,
wherein the processor
manages a plurality of documents distributed to a distribution destination on the distribution-pattern basis, and
if content of a document included in the plurality of documents is changed, redistributes, to a distribution destination, the document having the changed content and a different document managed in a distribution pattern of the document having the changed content.

6. The information processing apparatus according to claim 4,
wherein the processor
manages a plurality of documents distributed to a distribution destination on the distribution-pattern basis, and
if content of a document included in the plurality of documents is changed, redistributes, to a distribution destination, the document having the changed content and a different document managed in a distribution pattern of the document having the changed content.

7. The information processing apparatus according to claim 5,
wherein the processor further displays information regarding a redistribution history of a document on a display on the distribution-pattern basis.

8. The information processing apparatus according to claim 6,
wherein the processor further displays information regarding a redistribution history of a document on a display on the distribution-pattern basis.

9. The information processing apparatus according to claim 7,
wherein the processor further displays, on the display, information regarding a content change history of the document together with the information regarding the redistribution history.

10. The information processing apparatus according to claim 8,
wherein the processor further displays, on the display, information regarding a content change history of the document together with the information regarding the redistribution history.

11. The information processing apparatus according to claim 1,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

12. The information processing apparatus according to claim 2,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

13. The information processing apparatus according to claim 3,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

14. The information processing apparatus according to claim 4,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

15. The information processing apparatus according to claim 5,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

16. The information processing apparatus according to claim 6,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

17. The information processing apparatus according to claim 7,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

18. The information processing apparatus according to claim 8,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

19. The information processing apparatus according to claim 9,
wherein the processor manages the document and the distribution destination of the document on the distribution-pattern basis by associating document identification information for identifying the document and distribution destination identification information for identifying the distribution destination of the document with distribution pattern identification information that is identification information per distribution pattern.

20. A non-transitory computer readable medium storing a program causing a computer to execute a process comprising:
managing a document and a distribution destination of the document on a distribution-pattern basis for a distribution pattern of the document; and
processing the document on the distribution-pattern basis.
